(19) United States
(12) Patent Application Publication
(10) Pub. No.: US 2002/0018028 A1
(43) Pub. Date: Feb. 14, 2002

(54) Display device

(76) Inventor: Shigehiro Kadota, Tokyo (JP)

Correspondence Address: FITZPATRICK CELLA HARPER & SCINTO, 30 ROCKEFELLER PLAZA, NEW YORK, NY, 10112, US

(21) Appl. No.: 09/873,249

(22) Filed: Jun. 5, 2001

(30) Foreign Application Priority Data
Jun. 7, 2000 (JP) 171112/2000
May 31, 2001 (JP) 164785/2000

(51) Int. Cl. G09G 5/00

(52) U.S. Cl. 345/5

(57) ABSTRACT

A display system for displaying an image to be displayed by an image processing device, divisionally on a plurality of display devices. The display system includes the image processing device, a first display device for displaying an image on a first display unit, a second display device for displaying an image on a second display unit, a first coordinate value input device provided in correspondence with the first display unit, and a second coordinate value input device provided in correspondence with the second display unit, wherein the first display device has an input unit for receiving data from the first coordinate value input device and data from the second coordinate value input device.

### BACKGROUND OF THE INVENTION

1. Field of the Invention

The present invention relates to a display system and a display device, and more particularly to a display system having coordinate input devices such as digitizers.

2. Related Background Art

Some conventional display devices use digitizers as their coordinate data input devices. Although a digitizer connected to a conventional display device can input coordinate data in a range of its screen area, it does not deal with coordinate data input when a plurality of display devices connected to a display system are used.

Therefore, only a digitizer connected to an image processing device can input coordinate data by using a multi-display function realized, for example, by Windows 98.

Conventional coordinate input devices of display device are therefore associated with a problem that not all the display devices can input coordinate data in an multi-display environment.

In a system in which the same image is displayed on a plurality of display units, the configuration that a plurality of pointing devices are used, is disclosed in JP-A-11-134164.

In a system in which a large screen is formed by a combination of a plurality of display units, the configuration that one pointing device controls the large screen, is disclosed in JP-A-8-286835.

### SUMMARY OF THE INVENTION

In a conventional system for displaying an image on a screen (before division) by using a plurality of display units, it is not possible to enter coordinate value data compatible with all display units.

It is an object of the invention to provide a display system and a display device capable of entering coordinate value data compatible with digitizers of all display devices in a multi-display environment realizing the division display of a multi-display.

According one aspect of the invention, there is provided a display system for displaying an image to be displayed by an image processing device, divisionally on a plurality of display devices, the display system comprising: the image processing device; a first display device for displaying an image on a first display unit; a second display device for displaying an image on a second display unit; a first coordinate value input device provided in correspondence with the first display unit; and a second coordinate value input device provided in correspondence with the second display unit, wherein the first display device has an input unit for receiving data from the first coordinate value input device and data from the second coordinate value input device.

Since the outputs from the two coordinate data input devices are input to the first display device, the image processing device can obtain the data from the two coordinate value input devices, through communication with the first display device.

A conversion unit may be provided for converting coordinate data input from the first coordinate value input device, coordinate data input from the second coordinate value input device, or both the coordinate data, into coordinate data on a screen before division constituted of a screen of the first display unit and a screen of the second display unit. In this case, coordinate data compatible with the screen before division can be obtained even in a division display environment.

Namely, each coordinate value input device can obtain coordinate value data specific to each coordinate value input device. By converting the coordinate value data specific to each coordinate value input device into the coordinate value on the screen before division, it is possible to process the coordinate value data from each coordinate value input device without any discrimination therebetween.

The first display device may have an output unit for outputting data (including data with the partial or whole portion converted) from the first coordinate value input device and second coordinate value input device to the image processing device. In this case, the image processing device is not required to have a port for receiving coordinate data from each of the all coordinate value input devices. If the conversion unit is provided at the position such as in the first display device where the conversion unit can execute a conversion process before the first display device outputs data from each coordinate value input device to the image processing device, then the first display device can output coordinate data to the image processing device without adding an information for checking as to whether the coordinate data was supplied from which coordinate value input device.

It is preferable that the coordinate origin of one of the coordinate value input devices is made equal to the coordinate origin on the screen before division in order not to convert the coordinate value supplied from this coordinate value input device. In the embodiments to be later described, the coordinate origin of the first coordinate value input device is made equal to the coordinate origin on the screen before division. Accordingly, it is not necessary to convert the coordinate data supplied from the first coordinate value input device. It is therefore required to convert only the coordinate data supplied from the second coordinate value input device. Alternatively, the coordinate origin of the second coordinate value input device may be made equal to that on the screen before division so that only the coordinate data supplied from the first coordinate value input device is required to be converted.

And, in the above structure, it is not indispensable to connect the second coordinate value input device directly with the first display device. Like an embodiment as described below, a structure wherein the second coordinate value input device is connected with the second display device, so that via the second display device, the coordinate data is sent from the second coordinate value input device to the first display device may be desirably used.

According to another aspect of the present invention, there is provided a display device comprising: display means for displaying a partial area of a predetermined screen area; an input unit to which coordinate data is input from a coordinate value input device corresponding to another display means for displaying another area of the predetermined screen area; and a conversion unit for converting the coordinate data into coordinate data on the predetermined screen area.

### BRIEF DESCRIPTION OF THE DRAWINGS

FIG. 1 is a block diagram of a display device according to a first embodiment.

FIG. 2 is a flow chart illustrating the operation to be executed when two display devices with a digitizer of the first embodiment are used at the same time.

FIG. 3 is a block diagram showing a display system according to an embodiment.

### DETAILED DESCRIPTION OF THE PREFERRED EMBODIMENTS

Preferred embodiments of a display device and a display system according to the invention will be described with reference to the accompanying drawings. The display device of the embodiment is applied to a data projector.

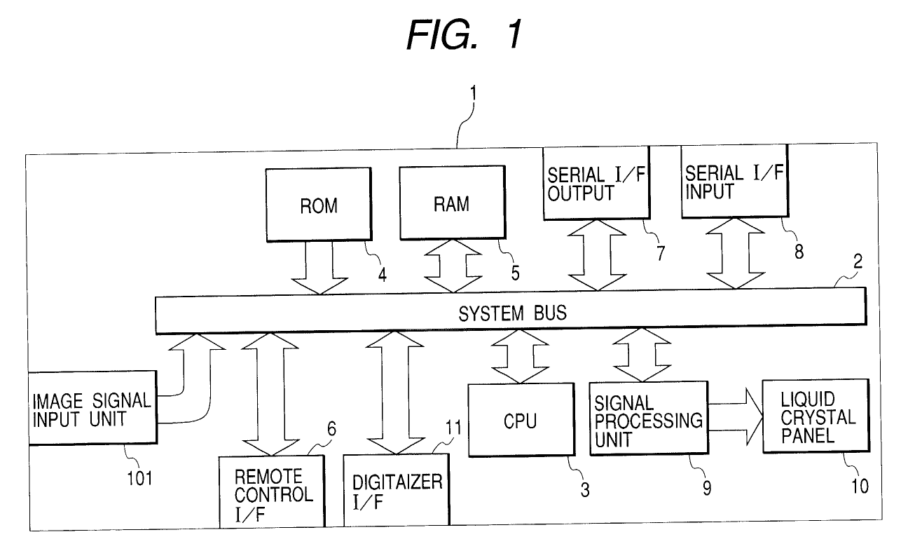

FIG. 1 is a block diagram of a first display device of the embodiment. In FIG. 1, reference numeral 1 represents a (first) display device. Reference numeral 2 represents a system bus to which various units of the display device are connected. Reference numeral 3 represents a CPU (central processing unit) for controlling the entirety of the display device, and executing various processes.

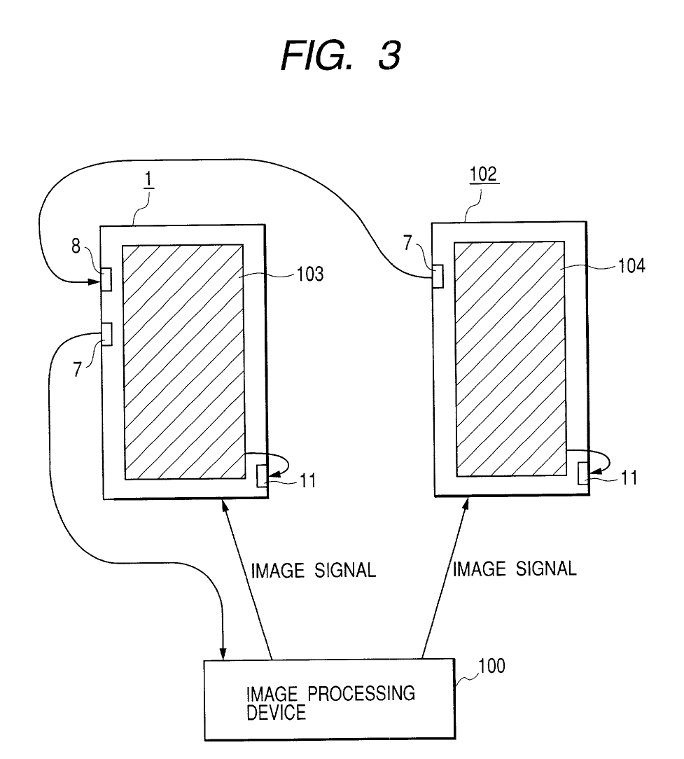

Reference numeral 4 represents a ROM which stores a program to be executed by CPU 3 and other data. Reference numeral 5 represents a RAM which stores image data to be described later and other data. Reference numeral 6 represents a remote control interface (I/F) for communicating with a remote controller of the display device 1. Reference numeral 7 represents a serial communication output interface (I/F) for communication (transmission) with an image processing device or the like. Reference numeral 8 represents a serial communication input interface (I/F) for communication (reception) with a second display device (FIG. 3) having the same structure as that of the first display device via a serial communication output interface 7 (FIG. 3) of the second display device. The serial communication input interface 8 receives coordinate information and the like input from a digitizer (second coordinate value input device, FIG. 3) connected to the second display device, the digitizer corresponding to a second display unit on which the second display device displays an image.

Reference numeral 9 represents a signal processing unit which converts image data or the like developed on RAM 5 into image drawing signals. A liquid crystal panel 10 is a display unit for displaying an image and is controlled by the display device. In place of the liquid crystal panel, a CRT, a plasma display panel, a flat display panel using cold cathode elements or the like may also be used. A projector may be used. In this embodiment, a projector using a liquid display panel is used. The liquid crystal panel 10 displays an image to be projected upon a projector screen. If the projector is of a reflection type, light is radiated to the front surface of the liquid crystal panel 10, and reflected by an image displayed on the liquid crystal panel 10 to be projected upon a projector screen via an optical system. If the projector is of a transmission type, light is radiated to the back surface of the liquid crystal panel to project an image displayed on the liquid crystal panel 10 upon a projector screen via an optical system. The details of the system of the projector after the optical system are omitted.

Reference numeral 11 represents a digitizer interface for a digitizer which is used as a coordinate data input device of the first display device. The digitizer interface 11 receives raw data from the digitizer. The type of the digitizer is not particularly limited.

Reference numeral 101 represents an image signal input unit to which image data is supplied from an image processing device to display an image on the display device. The image data input to the input unit 101 is stored in RAM 5 and then supplied to the liquid crystal panel 10 via the signal processing unit 9.

FIG. 3 is a block diagram showing the overall structure of a display system. Reference numeral 100 represents the image processing device which supplies image signals to the first display device 1 and second display device 102. The first display device 1 has a digitizer 103 as a first coordinate data input device connected to the first display device 1 and corresponding to the first display unit. The second display device 102 has a digitizer 104 as a second coordinate data input device connected to the second display device 102 and corresponding to a second display unit.

The second display device 102 has the structure same as that of the first display device 1. However, a signal from the communication output interface 7 of the second display device 102 is input not to the image processing device 100 but to the communication output interface 8 of the first display device 1. Coordinate data input from the second coordinate data input device of the second display device is input to the first display device.

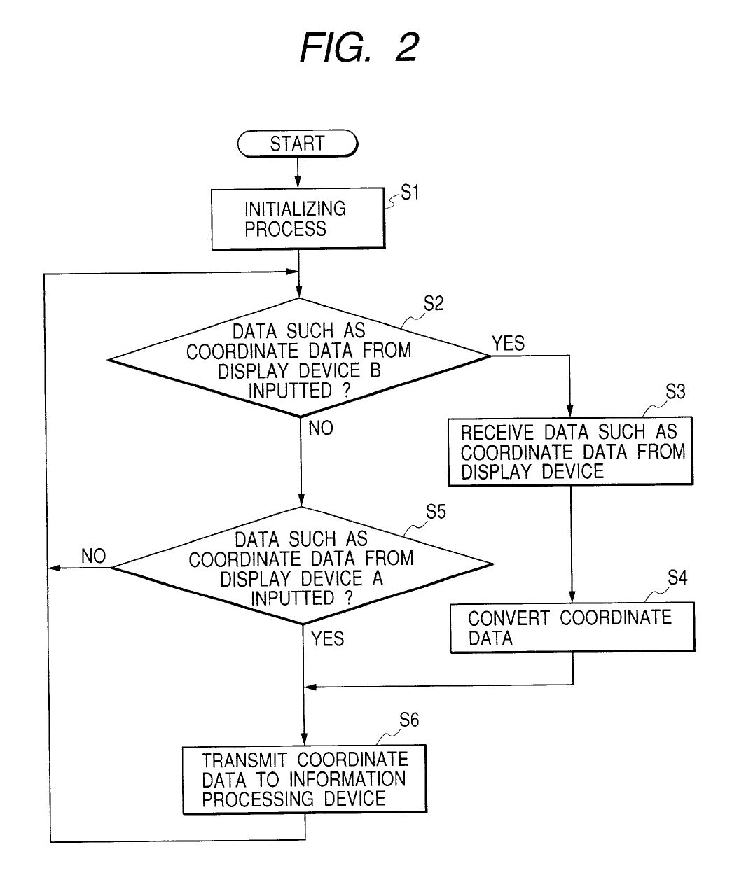

FIG. 2 is a flow chart illustrating the operation to be executed when two display devices with a digitizer of the first embodiment are used at the same time. This operation assumes a multi-display environment such as shown in FIG. 3 to be realized by Windows 98 or the like. The coordinate data input devices such as digitizers of the two display devices connected to the image processing device are connected in succession. The first display device is connected to the image processing device, and the second coordinate data input device of the second display device is connected to the first display device. Under this environment, the operation illustrated in the flow chart of FIG. 2 is executed.

The display device connected to the image processing device is called a display device A, whereas the display device connected to the display device A is called a display device B. In this embodiment, two display devices are used. The coordinate value data supplied from a digitizer of each display device is defined by using an absolute coordinate system having its origin at the upper left corner of the screen, an X-axis in the right direction, and a Y-axis in the down direction.

Step S1 is an initializing process for initializing a mouse driver and the like of the image processing device. The initializing process is executed when a power supply is turned on, when a reset button is depressed, or at other timings.

Step S2 is a judgement step for judging whether the display device B inputs coordinate value data or the like. If coordinate value data or the like is input from the display device B, then at Step S3 the display device A receives the coordinate data value or the like transmitted from the display device B via the communication interface. The coordinate value data of the display device B has as its origin the upper left corner of the screen thereof. It is therefore necessary to convert the coordinate system so that the coordinate value data has as its origin the upper left corner of the screen of the display device A in the multi-display environment.

At Step S4 the display device A converts the coordinate value data of the display device B so as to match the multi-display environment (divisional display). At Step S6 coordinate value data or the like is transmitted to the image processing device to thereafter return to Step S2.

If coordinate value data or the like is not input from the display device B at Step S2, then at Step S5 it is judged whether coordinate value data or the like is input from the display device A. If coordinate value data or the like is not input from the display device A, the flow returns to Step S2. If coordinate value data or the like is input from the display device A, at Step S6 the coordinate value data or the like is transmitted to the image processing device to thereafter return to Step S2.

In the embodiment, although two display devices are connected, three or more display devices may be connected. Also in this embodiment, although the program is stored in ROM of the display device, the embodiment is also applicable to the case wherein the program is externally supplied to the system or device. In this case, a storage medium storing the software program realizing the embodiment may be supplied to the system or device to make the system or device read the program from the medium to give the effects of the invention to the system or device.

Also in this embodiment, although a liquid crystal panel is used, elements on which micro mirrors are arrayed such as DMD (Texas Instruments) may be used if the projector of a reflection type is used.

The invention is applicable not only to a projector but also to other large screen display devices such as PDP.

In the first embodiment, although ROM is used as the non-volatile storage medium, other storage media may also be used such as a hard disk, a floppy disk, an optical disk, a magneto optical disk, a CD-ROM, a CD-R, a CD-RW, a DVD, a DVD-R, a DVD-RAM, a magnetic tape, and a non-volatile memory card.

As described above, presentation or the like can be performed by using a large screen display device for divisional display. In this case, in order to enter the coordinate value data or the like, a pen is used for each coordinate data input device such as a digitizer of each display device of the display system. As compared with presentation by using a mouse or the like, a presentation tool or the like can be handled with hands to indicate a desired image on the screen so that the presentation with a pen can be made easier.

In a multi-display environment such as Windows 98 for divisionally displaying an image on two juxtaposed display devices of the display system, coordinate value data input from the second display device is transmitted to the first display device which converts the coordinate value data into the coordinate value data of the multi-display environment coordinate system of the image processing device. In the multi-display environment with two juxtaposed display devices, all coordinate data input devices corresponding to the display units can be used by one pen.

According to the invention, in the state of divisional display, the coordinate value data input device of a simple structure can be provided for each divisional screen.

What is claimed is:

1. A display system for displaying an image to be displayed by an image processing device, divisionally on a plurality of display devices, the display system comprising:
said image processing device;
a first display device for displaying an image on a first display unit;
a second display device for displaying an image on a second display unit;
a first coordinate value input device provided in correspondence with the first display unit; and
a second coordinate value input device provided in correspondence with the second display unit,
wherein said first display device has an input unit for receiving data from said first coordinate value input device and data from said second coordinate value input device.

2. A display system according to claim 1, further comprising a conversion unit for converting coordinate data input from said first coordinate value input device, coordinate data input from said second coordinate value input device, or both the coordinate data, into coordinate value data on a screen before division constituted of a screen of said first display unit and a screen of said second display unit.

3. A display system according to claim 1, wherein either a coordinate origin of said first coordinate value input device or a coordinate origin of said second coordinate value input device is made equal to a coordinate value origin of a screen before division constituted of a screen of said first display unit and a screen of said second display unit, and the display system further comprises a conversion unit for converting data from said coordinate value input device whose coordinate origin is not made equal to the coordinate origin on the screen before division, into coordinate value data on the screen before division.

4. A display system according to claim 2 or 3, wherein said first display device has an output unit for outputting data from said first coordinate value input device and said second coordinate value input device to said image processing device, and said conversion unit executes a conversion process before said first display device outputs the data from the first or second coordinate value input device to said image processing device via said output unit.

5. A display system according to claim 2 or 3, wherein said first display device has said conversion unit.

6. A display system according to any one of claims 1 to 3, wherein said first display device has an output unit for outputting data from said first and second coordinate value input devices to said image processing device.

7. A display system according to any one of claims 1 to 3, wherein said second display device has a signal transmission unit for transmitting data from said second coordinate value input device to said first display device, and said first display device has a signal reception unit for receiving the data transmitted from the data transmitted from the signal transmission unit.

8. A display device comprising:
display means for displaying a partial area of a predetermined screen area;
an input unit to which coordinate data is input from a coordinate value input device corresponding to another display means for displaying another area of the predetermined screen area; and
a conversion unit for converting the coordinate data into coordinate data on the predetermined screen area.
